(19) United States
(12) Patent Application Publication
(10) Pub. No.: US 2021/0107810 A1
(43) Pub. Date: Apr. 15, 2021

(54) ELECTRICALLY CONDUCTIVE POLYMER THIN-FILMS

(71) Applicants: QUINTON WYATT, COLUMBIA, MO (US); MATTHIAS J. YOUNG, COLUMBIA, MO (US)

(72) Inventors: QUINTON WYATT, COLUMBIA, MO (US); MATTHIAS J. YOUNG, COLUMBIA, MO (US)

(21) Appl. No.: 17/070,284

(22) Filed: Oct. 14, 2020

Related U.S. Application Data
(60) Provisional application No. 62/914,681, filed on Oct. 14, 2019.

(51) Int. Cl. C02F 1/469

(52) U.S. Cl. CPC C02F 1/4691; C02F 2103/08; C02F 2201/46

(57) ABSTRACT

The present invention is directed to a porous electrode that includes a porous substrate and a coating. The porous substrate includes internal pores having internal pore surfaces. The coating covers at least a portion of the interior pore surfaces and is electrically conductive and ion-binding. The present is also directed to methods of using the porous electrode of the present invention in a variety of applications (e.g., water desalination and/or capacitive deionization) where an ion from a liquid electrolyte is bound to the substrate and/or released during electrochemical operation. The present invention is also directed to a capacitive deionization system for deionizing water that includes a compressible porous electrode of the present invention.

### CROSS-REFERENCE TO RELATED APPLICATIONS

This application is based on and claims priority to U.S. Provisional Application Ser. No. 62/914,681, filed on Oct. 14, 2019, which is incorporated herein by reference in its entirety.

### STATEMENT REGARDING FEDERALLY SPONSORED RESEARCH OR DEVELOPMENT

None.

### BACKGROUND OF THE INVENTION

### 1. Field of the Invention

The present invention relates to the field of electrodes, and more specifically, to porous electrodes.

### 2. Description of Related Art

Capacitive deionization (CDI) is a process under which charged particles (cations and/or anions) are removed from water and stored in one or more electrodes. CDI devices use electrodes to remove salt from water. A salty feed water flows into a CDI cell. The electrodes are charged with an electrical potential, and ions from the salt water bind to the electrodes to generate fresh water. When the electrodes are saturated with ions, the polarization is reversed and electrodes are discharged. This regenerates the CDI electrodes and forms an incrementally saltier waste stream. Because CDI recovers electrical energy when generating the waste stream, its maximum theoretical energy efficiency is >10% higher than reverse osmosis (RO). In RO, the energy from the dilution of the concentrated brine stream is not recovered by default. However, existing CDI electrodes fall well short of this theoretical limit. CDI has been identified as a cost-effective approach for desalination, particularly for brackish water with up to 0.3 wt % salt. State-of-the art CDI devices are only competitive with RO for low salinity feeds (<0.3 wt % salt) where the energetic cost to pump water through an RO membrane is high per solvated ion. CDI devices are commercially available from a number of domestic and international suppliers; however, industrial adoption of CDI has been hindered by the low energy efficiency of CDI versus reverse osmosis (RO) for higher salinity feed waters, and the high cost of ion exchange membranes used in CDI devices.

Conventional electrodes of the prior art, which are typically high surface area carbon, are limited by low capacity from double layer charge storage (ion-binding capacity), and slow charging rates from restricted transport (slow ion transport) through rigid nanoporous electrodes. Carbon is appealing because it is electrically conductive, has high surface area (exceeding 1000 m²/g), and has long cycling stability. However, the gravimetric specific capacitance of carbon is low (10-100 F/g), which requires a greater mass of carbon for appreciable ion removal, leading to thicker (μm+) nanoporous electrodes. Diffusion through these thick nanoporous electrodes introduces diffusion overpotentials, which limits performance and leads to energy loss, even when convective flow is employed.

Battery-like materials which undergo bulk ion insertion, such as sodium manganese oxide (NMO) and silver (Ag), have been explored to replace carbon electrodes for CDI in recent literature. However, compared with bulk ion insertion materials (e.g., lithium ion battery materials,) surface redox reactions provide significant cost advantages in both cost per unit energy and power (i.e., capacity and rate). This is because bulk ion insertion materials require slow solid-state ion diffusion to access all of the capacity. As such, bulk ion insertion (lithium ion battery) electrodes require hours to charge. Furthermore, degradation is a significant problem in bulk ion insertion materials (due to mechanical expansion and contraction) leading to cycle lives of only 100s of cycles.

Slow solid-state diffusivity of ions in solid-state faradaic materials limits the rate capability of bulk ion insertion materials, and introduces energetic losses from overpotentials needed to drive the ion insertion reactions. On average, ion diffusivity in solid state materials is 4+ orders of magnitude slower than liquid phase diffusivity. Thus, thicker dimensions of solid phase active materials slow the rate of ion uptake at a rate that scales with this four-order-of-magnitude difference.

Compressible foam electrodes have also been explored. However, such electrodes employ boutique materials or processes (e.g. carbon foam), which are not readily accessible and provide limited control over the foam structure.

Further growth of CDI utilization necessitates electrode development to improve energy efficiency and eliminating the need for expensive ion exchange membranes.

### BRIEF SUMMARY OF THE INVENTION

In a first aspect, the present invention is directed to a porous electrode. The electrode includes a porous substrate and a coating. The porous substrate includes internal pores which include internal pore surfaces. The coating covers at least a portion of the interior pore surfaces. The coating is electrically conductive and ion-binding.

In certain embodiments, the porous substrate is compressible. Preferably, the porous substrate is a compressible foam, and the porous electrode is a compressible foam electrode.

In certain embodiments, the coating is formed by sequential infiltration synthesis. In certain embodiments, the coating includes a polymer. Preferably, the polymer is formed by reacting a monomer and an oxidant. Preferably, the monomer is selected from the following: substituted or unsubstituted pyrrole, aniline, para-phenylenediamene, thiopene, cyclic or acyclic conjugated monomers containing N, and/or S heteroatoms, and combinations thereof. More preferably, the monomer is selected from the following: 3,4-ethylenedioxythiophene, n-methyl aniline, n-methyl pyrrole, and combinations thereof. Preferably, the polymer is poly(3,4-ethylenedioxythiophene). Preferably, the oxidant is selected from the following: halides, metal halide oxidants, and combinations thereof. In certain embodiments where the oxidant is a metal halide oxidant, the metal halide is selected from the following: molybdenum pentachloride (MoCl₅), iron chloride (FeCl3), tin chloride (SnCl4), arsenic chloride (AsCl5), rhenium chloride (ReCl5), copper chloride (CuCl2), palladium chloride (PdCl2), antimony chloride (SbCl5), and combinations thereof.

In certain embodiments, the thickness of the coating ranges from 1 to 1000 nm. More preferably, the coating is approximately 1/100^{th} the diameter of the pores of the porous substrate. In certain embodiments, the electrical conductivity of the coating ranges from 1 to 5,000 S/cm. More preferably, the electrical conductivity is greater than 5,000 S/cm. In certain embodiments, the sorption capacity of the coating ranges from 10 to 2000 F/g. More preferably, the sorption capacity is greater than 500 F/g. In certain embodiments, the resistance of the coating is 1 to 10,000 Ohms. More preferably, the resistance is about 10 Ohms.

In certain embodiments, the porosity of the porous substrate ranges from 0.05% to 99%. In certain embodiments, the surface area of the porous substrate ranges from 0.1 to 100 m²/g.

In a second aspect, the present invention is directed to a method of using the porous electrode of the first aspect of the invention in a variety of applications, including, but not necessarily limited to: CDI, electrical energy storage, water remediation and reuse, ion sensors, industrial separation processes (using coatings selective toward specific ions), therapeutic ion release, and any other applications where an ion from a liquid electrolyte (solution) is bound to the substrate and/or released during electrochemical operation (charge or discharge).

In a third and fourth aspect, the present invention is directed to a method of deionizing water. The method of the third aspect includes the following steps: applying a charge to the porous electrode of the first aspect of the invention; and contacting the water with the porous electrode. The method of the fourth aspect includes the following additional steps: the applying step includes applying a potential difference over two porous electrodes of the first aspect of the invention, and the contacting step includes contacting the water with each of the porous electrodes.

In a fourth aspect, the present invention is directed to a capacitive deionization system for deionizing water. The system includes a compressible porous electrode of the first aspect of the present invention; and a device configured to mechanically compress the porous compressible electrode.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means of the instrumentalities and combinations particularly pointed out in the appended claims.

### BRIEF DESCRIPTION OF THE DRAWINGS

FIG. 1 depicts an exemplary compressible foam electrode of the present invention that is generally designated with the numeral 10.

FIGS. 2(a) and 2(b) depict an exemplary CDI system of the present invention that is generally designated with the numeral 22.

FIG. 3 is a chart comparing the electrochemical properties (current and voltage) of a bare stainless steel (SS) disc to a stainless steel disc with a polypyrrole coating.

FIG. 4 is a chart comparing the electrochemical properties (current and voltage) of a bare stainless steel (SS) disc to a stainless steel disc with a polyPPDA/pyrrole coating.

FIG. 5 is a chart comparing the electrochemical properties (current and voltage) of a bare stainless steel (SS) disc to a stainless steel disc with a poly-n-methyl-pyrrole coating.

### DETAILED DESCRIPTION OF PREFERRED EMBODIMENT

In a first aspect, the present invention is directed to a porous electrode. The surfaces of the porous electrode, including the interior surfaces of the pores of the porous electrode, are functionalized by applying an electrically conductive and electrochemical ion binding coating to the surfaces of a porous substrate. In other words, the porous substrate is impregnated with an electrically-conductive and redox-active film or coating. At the same time, the mechanical properties of the porous substrate are generally preserved. In certain embodiments, the porous electrode is compressible and may be a compressible foam electrode.

The porous electrodes are expected to be suitable for use in a variety of applications, including, but not necessarily limited to: CDI, electrical energy storage, water remediation and reuse, ion sensors, industrial separation processes (using coatings selective toward specific ions), and therapeutic ion release. In general, the porous electrodes are expected to be suitable for use in any application where an ion from a liquid electrolyte (solution) is bound to the substrate and/or released during electrochemical operation (charge or discharge).

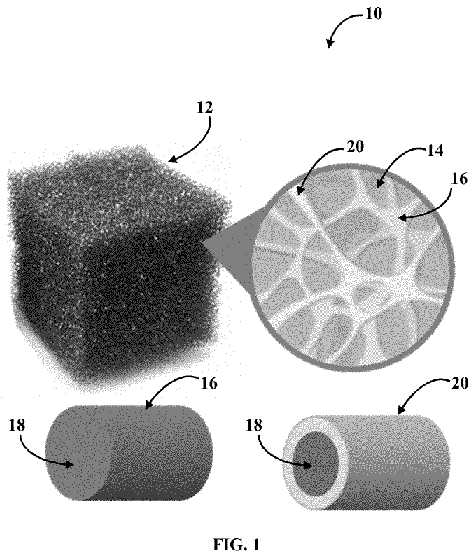

In the exemplary embodiment shown in FIG. 1, compressible foam electrode 10 comprises a compressible foam 12. Compressible foam 12 comprises interior pores 14 having interior surfaces 16. Interior pores 14 are defined in such embodiment by fibers 18. Interior surfaces 16 of interior pores 14 are covered by coating 20. Although interior surfaces 16 of interior pores 14 are completely covered by coating 20 in FIG. 1, it is expected that coating 20 may cover only a portion of interior surfaces 16 of interior pores 14.

The coating is preferably formed via sequential infiltration synthesis (SIS), a process that is related to molecular layer deposition. SIS employs sequential surface reactions of gas phase precursors to grow nanoscale thin films with atomic-scale precision within the high surface area pores of the porous substrate, as well as on the exterior surfaces of the porous substrate.

It has been surprisingly found that—in spite of the use oxidants such as MoCl₅ which are capable of decomposing substrates and monomers which are used to form the coating—the coating may be formed without causing material chemical decomposition of certain substrates, including stainless steel and foam. And to the extent that the substrates or monomers do chemically decompose during the formation of the coating, it does not significantly impact the mechanical properties of the substrates. In view of these findings, it is now expected that the formation of the coating may similarly have little to no impact on the mechanical properties of other suitable porous substrates.

The coating may be configured to bind anions, cations, or combinations thereof. In certain embodiments, the coating comprises a polymer, which may be formed by reacting a monomer and an oxidant. The polymer coating may be formed on the surfaces of the porous substrate using SIS, although SIS may be used to form alternate types of coatings. Alternate types of coatings include, but are not necessarily limited to, inorganic coatings, organic coatings, and metal-organic coatings. Inorganic coatings include, but are not necessarily limited to metal oxides, nitrides, sulfides, fluorides, and selenides. Inorganic coatings may be formed by using alternating exposures of metal organic precursors and coreactants (e.g., water, ozone, ammonia, H₂S, HF, HSe). Organic coatings may be formed by using alternating exposures of bifunctional organic molecules with complementary reactive functional groups. Metal-organic coatings may be formed using alternating exposures of a metal organic precursor and a functional (bi, tri quadra, etc.) organic monomer (e.g., diol).

Suitable anion-binding polymers include, but are not necessarily limited to, substituted or unsubstituted poly(3,4-ethylenedioxythiophene) (PEDOT), poly(n-methyl aniline) poly(n-methyl pyrrole), polyaniline, polypyrrole, poly(para-phenylenediamene), polythiophene, conjugated cyclic and/or acyclic monomers with one or more N or S heteroatom, and combinations thereof. Suitable monomers for producing anion-binding polymers include, but are not necessarily limited to, substituted or unsubstituted pyrrole, aniline, para-phenylenediamene, thiopene, ethylenedioxythiophene, and other cyclic or acyclic conjugated monomers containing N and/or S heteroatoms, and combinations thereof. Suitable substitutions may include, but are not necessarily limited to, one or more —R groups from the classes: alkyl (methyl, ethyl, propyl, butyl, isobutyl, etc.), alkenyl, phenyl, hydroxyl, carbonyl, aldehyde, carbonate ester, carboxylate, carboxyl, carboalkoxy, methoxy, ether, hemiacetal, hemiketal, acetal, ketal, carboxamide, amine, imine, imide, azo, nitrile, pyridyl, carbamate, sulfhydryl, or sulfide functionality. These —R group substitutions may be located on the heteroatom or on any other atom in the molecule. Exemplary substitutions include N-methyl aniline, N,N-dimethylaniline, 1-methyl aniline, 2-methyl aniline, 3-methyl aniline, 1,2-dimethylaniline, 1,3-dimethylaniline, N,1,2-trimethylaniline, N,1,3-trimethylaniline, N,1,2,3-tetramethylaniline, N-methyl pyrrole, and 1-methyl pyrrole. Exemplary monomers include 3,4-ethylenedioxythiophene, n-methyl aniline, n-methyl pyrrole, and combinations thereof.

Suitable cation-binding polymers include, but are not necessarily limited to, substituted or unsubstituted polyfuran, polyphenol, polyresorcinol, polyhydroquinone, polyquinone, other cyclic or acyclic conjugated monomers containing O heteroatoms, and combinations thereof. Suitable monomers for producing cation-binding polymers include, but are not necessarily limited to substituted or unsubstituted furan, phenol, pyrocatechol, resorcinol, hydroquinone, quinone, and other cyclic or acyclic conjugated monomers containing O heteroatoms and combinations thereof. Suitable substitutions may include, but are not necessarily limited to, one or more —R groups from the following classes: alkyl (methyl, ethyl, propyl, butyl, isobutyl, etc.), alkenyl, phenyl, hydroxyl, carbonyl, aldehyde, carbonate ester, carboxylate, carboxyl, carboalkoxy, methoxy, ether, hemiacetal, hemiketal, acetal, ketal, carboxamide, amine, imine, imide, azo, nitrile, pyridyl, carbamate, sulfhydryl, or sulfide functionality. These —R group substitutions may be located on the heteroatom or on any other atom in the molecule. Exemplary substitutions include N-methyl aniline, N,N-dimethylaniline, 1-methyl aniline, 2-methyl aniline, 3-methyl aniline, 1,2-dimethylaniline, 1,3-dimethylaniline, N,1,2-trimethylaniline, N,1,3-trimethylaniline, N,1,2,3-tetramethylaniline, N-methyl pyrrole, 1-methyl pyrrole, and combinationsthereof.

Suitable oxidants include, but are not necessarily limited to, halides and metal halide oxidants. Suitable halides include, but are not necessarily limited to, chlorine gas (Cl₂). Suitable metal halide oxidants include, but are not necessarily limited to, molybdenum pentachloride (MoCl₅), iron chloride (FeCl₃), tin chloride (SnCl₄), arsenic chloride (AsCl₅), rhenium chloride (ReCl₅), copper chloride (CuCl₂), palladium chloride (PdCl₂), and antimony chloride (SbCl₅).

In certain embodiments, the coating may comprise two or more different compounds, for example two or more polymers. In such embodiments, the compounds may be all anionic-binding, all cationic-binding or combinations thereof. When multiple polymers are employed, SIS may be used to form polymer alloys by alternating cycles to produce the desired ratios of the polymers, as discussed in more detail below.

Due to the utilization of nanoscale redox coatings, the rate of ion saturation in the porous electrodes (˜1 second charge time) is expected to be much higher than in commercially available capacitive deionization electrodes of the prior art (˜1 hour charge time). The thickness of the coating is typically less than 100 nm, thus reducing the length scale for solid state diffusion and enhancing the energy efficiency of CDI. A suitable thickness of the coating may range from 1 to 1000, from 2 to 100, or from 5 to 10 nm. Preferably, the thickness of the coating is approximately 1/100^{th} the diameter of the voids or internal pores of the porous substrate. The utilization of a nanoscale coating is expected to eliminate the detrimental effect of slow solid-state diffusion by reducing the physical dimensions of redox materials from the micron scale to the nanoscale.

The electrical conductivity of the coating may range from 1 to 5,000, from 100 to 2,000, or from 200 to 1,000 S/cm. In certain embodiments, the electrical conductivity of the coating is greater than 5,000 S/cm. The sorption capacity of the coating may range from 10 to 2000, from 100 to 1000, or from 200 to 500 F/g. In certain embodiments, the sorption capacity is greater than 500 F/g. The resistance of the coating may range from 1 to 10,000, from 5 to 1000, or from 10 to 100 Ohms. In certain embodiments, the resistance of the coating is approximately 10 Ohms. The resistance of the coating may be “tuned” by varying the number of layers of the coating that are applied. For example, as the thickness increases, the resistance decreases. The aforementioned properties may be affected by the monomers and oxidants utilized.

A variety of compressible or incompressible porous substrates may be utilized to prepare the porous electrodes of the present invention. Suitable porous substrates include, but are not necessarily limited to: plastics, rubbers, and polymers (such as polyurethane, polyethylene-vinyl acetate, polyethylene, nitrile rubber, polychloroprene, polypropylene, polystyrene, polyvinyl chloride, silicone, neoprene, styrene butadiene, polyisoprene, polyimide, polyvinylidene fluoride, polyaniline, polypyrrole, polyethylenedioxythiophene, polytetrafluoroethylene, cellulose, etc.); porous carbons (activated carbon, graphene, reduced graphene oxide, carbon nanotubes, buckeyballs, grafoil, graphite, char, activated charcoal, etc.); inorganic/ceramics (inorganic oxides, sulfides, nitrides, fluorides, selenides, tellurides; metal oxides, sulfides, nitrides, fluorides, selenides, tellurides; transition metal oxides, sulfides, nitrides, fluorides, selenides, tellurides; redox-active inorganic oxides, sulfides, nitrides, fluorides, selenides, tellurides); and alloys and/or composites thereof. Exemplary porous substrates include, but are not necessarily limited to: polyurethane foam, grafoil sheeting, silica aerogel, an activated carbon/polymer composite, a composite of activated carbon, polymer binder, and mixed metal oxides, and sheeting of polystyrene spheres held together with a binder. The porosity of the porous substrates may range from 0.05% to 99%, from 10% to 95%, or from 50% to 90%.

The thickness of the porous substrates may range from 0.01 to 100, from 0.1 to 10, or from 1 to 5 inches. The porosity of the porous substrates may range from 10 to 99%, from 50 to 97%, or from 70 to 95%. The surface area of the porous substrates may range from 0.1 to 100, from 1 to 50, or from 2 to 10 m²/g.

A wide variety of compressible foams with a wide variety of properties (e.g., porosity, density, and surface area) may be used to form compressible foam electrodes. Many suitable foams are very low cost and readily available. Suitable foams include, but are not necessarily limited to, polymeric foams. Suitable polymeric foams include, but are not necessarily limited to, polyurethane, polyimide, polyethylene-vinyl acetate, polyethylene, nitrile rubber, polychloroprene, polypropylene, polystyrene, polyvinyl chloride, silicone, and combinations thereof.

Compressible porous electrodes, including compressible foam electrodes, allow for rapid liquid phase ion transport from forced convection. Mechanical compression of compressible porous electrodes enables the electrodes to exceed the charging rates of incompressible electrodes where ions must diffuse through tortuous paths in the electrodes. The mechanical compression of the compressible porous electrodes can be rapid (less than one second), thereby allowing for minimal energetic losses from diffusion overpotentials.

The thickness of the electrically conductive and ion binding coating drives the rate of ion uptake (thicker films charge slower due to slow solid-state diffusion), and compressible porous electrodes, including compressible foam electrodes, act as compressible supports to allow for controlled transport of ions through the liquid-filled voids, which may use forced convection through mechanical compression. Within this construct, the number of salt ions in the liquid phase within the compressible electrode can be written as N_{L}=VϕC_{S}, where V is the volume of the electrode, ϕ is the porosity of the electrode, and C_{S} is the concentration of salt within the liquid phase. The amount of ions that can be absorbed by the electrically conductive and ion binding coating can be written as N_{S}=Atρ_{c}C_{P}nF, where A is the surface area per volume of the foam electrode, t is the thickness of the coating, ρ_{c} is the density of the coating, C_{P} is the specific charge capacity of the coating material, n is the molar ratio of electrons to ions absorbed, and F is Faraday's constant.

The porous electrodes are reusable. Once the porous electrodes are saturated with ions, the polarization is reversed and the electrodes are discharged. This regenerates the porous electrodes. Unlike battery materials electrodes of the prior art (e.g., sodium manganese oxide or silver), the porous electrodes require only seconds (as opposed to hours) to charge. Furthermore, while degradation is a significant problem for battery materials electrodes of the prior art, the redox coatings used in the porous electrodes have been demonstrated to be stable for greater than 100,000 cycles.

The porous electrodes are expected to have high salt sorption capacities, high ion selectivity, and minimal diffusion overpotential. As compared to the capacitive deionization electrodes of the prior art, the porous electrodes are expected to: have a higher desalination efficiency, have a higher specific capacitance, have lower diffusion loss, have lower production costs, and result in a reduction in energy consumption. Because the porous electrodes are expected to have a higher specific capacitance than capacitive deionization electrodes of the prior art, the surface area of the porous electrodes may be lower.

As noted above, the SIS process that may be employed to form the coating is similar to MLD. The difference between SIS and MLD is that SIS employs longer dose and purge times to allow for uniform and conformal coatings within the internal surface area of the porous substrate. The self-limiting nature of MLD-type reactions allows for the uniform and conformal coating of these high-surface area 3D substrates with ultrathin films. SIS processes are known in the art, and a suitable process is disclosed in the following references which are incorporated by reference with respect to their disclosure of the SIS process: (1) Biswas, M.; Libera, J. A.; Darling, S. B.; Elam, J. W. New Insight into the Mechanism of Sequential Infiltration Synthesis from Infrared Spectroscopy. Chem. Mater. 2014, 26, 6135-6141. https://doi.org/10.1021/cm502427q; (2) Elam, J. W.; Biswas, M.; Darling, S.; Yanguas-Gil, A.; Emery, J. D.; Martinson, A. B. F.; Nealey, P. F.; Segal-Peretz, T.; Peng, Q.; Winterstein, J.; Liddle, J. A.; Tseng, Y.-C. New Insights into Sequential Infiltration Synthesis. ECS Trans. 2015, 69, 147-157. https://doi.org/10.1149/06907.0147ecst; (3) Waldman, R. Z.; Jeon, N.; Mandia, D. J.; Heinonen, O.; Darling, S. B.; Martinson, A. B. F. Sequential Infiltration Synthesis of Electronic Materials: Group 13 Oxides via Metal Alkyl Precursors. Chem. Mater. 2019, 31, 5274-5285. https://doi.org/10.1021/acs.chemmater.9b01714; and (4) Barry, E.; Mane, A. U.; Libera, J. A.; Elam, J. W.; Darling, S. B. Advanced Oil Sorbents Using Sequential Infiltration Synthesis. J. Mater. Chem. A 2017, 5, 2929-2935. https://doi.org/10.1039/C6TA09014A.

In certain embodiments, the SIS method includes the following steps: positioning a porous substrate in a molecular layer deposition (MLD) reactor chamber; and performing a first super-cycle, wherein the first super-cycle comprises a first sub-cycle and a second sub-cycle. The first sub-cycle includes the following steps: dosing the surface of the porous substrate with a first gas-phase precursor for a first-gas-phase precursor dosing time, which may range from 1 to 200, from 5 to 60, or from 10 to 30 seconds; and purging a portion of the first-gas phase precursor for a first gas-phase precursor purging time, which may range from 10 to 1000, from 30 to 500, or from 60 to 120 seconds. The second sub-cycle includes the following steps: dosing the surface of the porous substrate with a second-gas phase precursor for a second-gas phase precursor dosing time, which may range from 1 to 200, from 5 to 60, or from 10 to 30 seconds; and purging a portion of the second-gas phase precursor for a second-gas phase precursor purging time, which may range from 10 to 1000, from 30 to 500, or from 60 to 120 seconds. The number of first super-cycles may range from 1 to 1000, and 10 to 100. The first super-cycle includes a number of first sub-cycles which may be from 1 to 20, and from 1 to 5 and a number of second sub-cycles which may be from 1 to 20, and from 1 to 5 sub-cycles.

The temperature of the MLD reactor must be low enough to allow for the formation of the electrically conductive and ion binding coating without causing the porous substrate to degrade or decompose. The temperature of the MLD reactor may range from 50 to 350, from 80 to 150, or from 90 to 120 degrees Celsius. The pressure of the reactor may range from 0.5 to 10, from 0.6 to 5, or from 0.7 to 1.3 Torr. Preferably, in order to prevent condensation, the temperature of the oxidant is held at a temperature that is about ten degrees Celsius lower than the temperature of the MLD reactor.

The dosing and purging steps may be carried out under an inert carrier gas, preferably argon or nitrogen. The flow rate of the inert carrier gas may range from 10 to 1000, from 50 to 500, or from 150 to 250 standard cubic centimeters per minute. The precursor dose pressure may range from 0.1 to 10,000, from 1 to 1000, or from 10 to 200 mTorr.

During the dosing steps of the first and second sub-cycles, the respective gas-phase precursors infiltrate the surfaces of the porous substrate, including the interior surfaces of the pores of the porous substrate, where the respective gas-phase precursors then react and nucleate to form the electrically conductive and electrochemical ion binding coating. The precursor dose times and purge times are dependent on the vapor pressure of the precursor, the diffusion properties of the precursor, and the type and the dimensions of the porous substrate to be coated. For example, a dose time of at least 30 seconds is typically required in order to infiltrate a one-inch square of polyurethane sponge. The ˜30 s precursor dose times and ˜60 s purge times are appropriate for example in ˜1″ cube foam sponge substrates and ˜100 mTorr precursor vapor pressures. Longer dose times are required for lower vapor pressure precursors and/or thicker porous substrates. Longer purge times are required for higher vapor pressure precursors and/or thicker porous substrates.

In certain embodiments, the method of forming the coating may include an additional step in order to pretreat the surface of the porous substrate to reduce the potential for the porous substrate to react with the electrically conductive and ion binding coating. This can be accomplished by forming a passivation layer on the porous substrate via SIS prior to performing a super-cycle. Suitable SIS methods for forming such a passivation layer are described in various references referred to above which are incorporated by reference with respect to their disclosure of the SIS process. The passivation layer may be a metal oxide. Suitable metal oxides, include, but are not necessarily limited to, aluminum oxide (Al₂O₃), zinc oxide (ZnO), and titanium oxide (TiO₂).

In certain embodiments, the SIS method may be utilized to form coatings that are alloys of polymers. These alloys can be formed by interdigitating varying cycles of A/B doses of one monomer (A) and an oxidant (B) and C/D cycles of a second monomer (C) and an oxidant (D)—either the same or a different oxidant as used in (B). The relative composition of monomers within the composite polymer can be varied by adjusting the ratio of A/B cycles relative to C/D cycles, and the total thickness of the polymer can be adjusted by tuning the total number of both A/B and C/D cycles. This allows for control of the molecular structure to provide enhanced electrical conductivity, redox activity, ion binding selectivity, etc., where the final molecular structure and the resulting nano- and molecular structure of the polymer films govern these properties of interest. In such embodiments, the method of forming the coating comprises the following additional steps: a second super-cycle, wherein the second super-cycle comprises a third sub-cycle and a fourth sub-cycle. The third sub-cycle comprises the following steps: dosing the surface of the porous substrate with a third gas-phase precursor for a third gas-phase precursor dosing time, which may range from 1 to 200, from 5 to 60, or from 10 to 30 seconds; and purging a portion of the third gas phase precursor for a third gas-phase precursor purging time, which may range from 10 to 1000, from 30 to 500, or from 60 to 120 seconds. The fourth sub-cycle comprises the following steps: dosing the surface of the porous substrate with a fourth gas phase precursor for a fourth gas phase precursor dosing time, which may range from 1 to 200, from 5 to 60, or from 10 to 30 seconds; and purging a portion of the fourth gas phase precursor for a fourth gas phase precursor purging time, which may range 10 to 1000, from 30 to 500, or from 60 to 120 seconds. The number of second super-cycles may be from 1 to 100, and from 10-50 super-cycles. The second super-cycle includes a number of third sub-cycles which may be from 1 to 20, and from 1 to 5 and a number of fourth sub-cycles which may be from 1 to 20, and from 1 to 5.

In certain embodiments, the number of first super-cycles is the same as the number of second super-cycles. In certain embodiments, the number of first super-cycles is higher than the number of second super-cycles or lower than the number of second super-cycles. In certain embodiments, all of the first super-cycles are completed prior to all of the second super-cycles. In certain embodiments, all of the second super-cycles are completed prior to all of the first super-cycles.

The third gas-phase precursors may be selected from the same categories and lists of first anion-binding and cation-binding monomers listed above. Similarly, the fourth gas-phase precursors may be selected from the same categories and lists of oxidants listed above.

In a second aspect, the present invention is directed to a method of using the porous electrode of the first aspect of the invention in a variety of applications, including, but not necessarily limited to: CDI, electrical energy storage, water remediation and reuse, ion sensors, industrial separation processes (using coatings selective toward specific ions), therapeutic ion release, and any other applications where an ion from a liquid electrolyte (solution) is bound to the substrate and/or released during electrochemical operation (charge or discharge). The methods of using the porous electrodes in such applications will be readily apparent to one of ordinary skill in the art, and generally include applying a charge to the porous electrode and contacting a liquid electrolyte solution with the electrode. Further, although the methods discussed herein are discussed with respect to a porous electrode, the present application encompasses use of any of the thin films described herein on a nonporous substrate in any of the disclosed methods. The non-porous substrate may be formed of any of the materials described with respect to the porous electrodes, and any other suitable substrates, which can readily be identified by one of ordinary skill in the art.

In a third aspect, the present invention is directed to a method of deionizing water utilizing a porous electrode of the first aspect of the invention. The method includes the following steps: applying a charge to the porous electrode; and contacting the water with the porous electrode. In certain embodiments, the porous electrode is compressible and is mechanically compressed in order to increase the rate of ion diffusivity within the compressible porous electrode. Once the porous electrodes are saturated with ions, the polarization may be reversed and the electrodes discharged.

In a fourth aspect, the present invention is directed to a method of deionizing water utilizing two porous electrodes of the first aspect of the invention. The method includes the following steps: applying a potential difference over the two porous electrodes; and contacting the water with each of the porous electrodes. In certain embodiments, anion uptake takes place in the positively charged porous electrode, and anion rejection takes place in the counter (the negatively charged) porous electrode in order to balance the capacity between the two electrodes. In certain embodiments, the counter porous electrode may employ a cation-binding electrode coating to enable desalination (removal of both cations and anions). In certain embodiments, one or both of the porous electrodes are compressible and are mechanically compressed in order to increase the rate of ion diffusivity within one or both of the porous electrodes. Once the porous electrodes are saturated with ions, the polarization may be reversed and the electrodes discharged.

In a fifth aspect, the present invention is directed to a capacitive deionization system for deionizing water. The system includes at least one compressible porous electrode of the first aspect of the present invention; and a first device configured to mechanically compress the compressible porous electrode. Suitable devices include, but are not limited to, pistons, rollers, and bellows. In certain embodiments, the device includes two compressible porous electrodes of the first aspect of the present invention and two devices configured to mechanically compress each of the compressible porous electrodes.

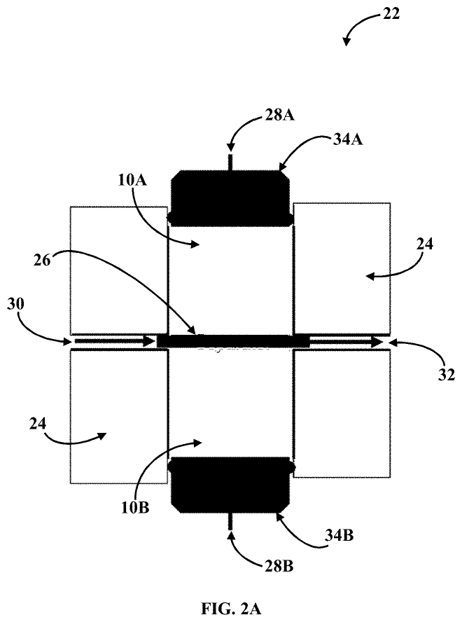

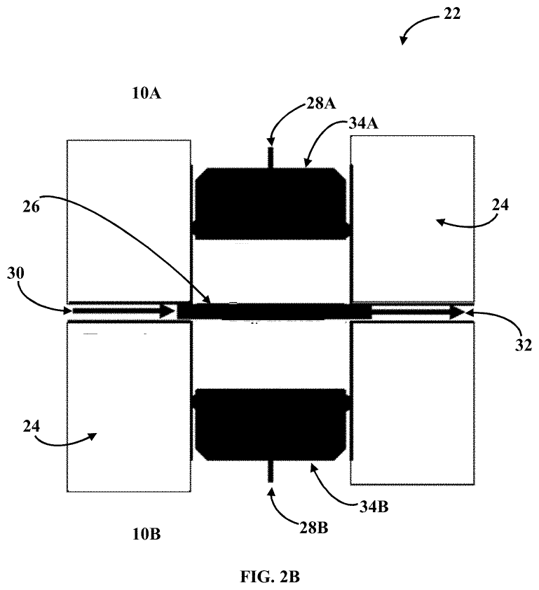

An exemplary embodiment of the system of the fifth aspect of the present invention is shown in FIGS. 2(a) & (b) and is generally designated with the numeral 22. System 22 may be utilized to perform the methods of the second or third aspects of the present invention. System 22 includes two compressible foam capacitive deionization electrodes 10a and 10b positioned within body 24 and separated by separator 26. A potential difference may be applied over the two electrodes 10A and 10B via electrical connections 28A and 28B, such that one of the electrodes 10A has a positive charge and one of the electrodes 10B has a negative charge. Water is fed to system 22 via inlet 30. One or both of the charged electrodes 10A and 10B is brought into contact with the water. As the water contacts electrodes 10A and 10B, anions will diffuse into the positively charged electrode 10A (the anode), and cations will diffuse into the negatively charged electrode 10B (the cathode), resulting in the desalination of the water, which then exits system 22 via outlet 32. As shown in FIG. 2(b), the pistons 34A and 34B are operable to apply mechanical compression to the respective electrodes 10A and 10B in order to increase the rate of diffusivity of the ions contained in the water into the electrodes. A salinity probe (not shown) may be attached to outlet 32 in order to ascertain the salinity of the water. Once the compressible foam electrodes are saturated with ions, the polarization may be reversed and the electrodes discharged.

An exemplary method for forming a compressible foam electrode of the first aspect of the invention is demonstrated by the following non-limiting example.

### Example 1

The method of functionalizing a surface of a foam to form a compressible foam electrode may be carried out via SIS of an inert sponge. SIS may be carried out under ˜1 Torr of inert carrier-gas feed (e.g. argon), in a hot-walled viscous-flow atomic-layer-deposition-type reactor at ˜150 degrees Celsius. In order to produce a conductive and redox-active polymer coating on the foam, gas-phase precursors may be selected which react in sequence to produce a (a) conductive and (b) redox-active coating. For example, for the growth of polyethylenedioxythiophene (PEDOT) within a polymer foam by SIS, two precursors, ethylenedioxythiophene (EDOT) and an oxidant, (e.g. MoCl₅) are used. EDOT (A) and MoCl₅ (B) may be dosed separately in A/B cycles with a purge time in between each precursor dose. Preferably, in order to prevent condensation, the temperature of the oxidant may be held at a temperature that is about ten degrees Celsius lower than the temperature of the reactor (˜140 degrees Celsius). Typical dose times for one SIS cycle are 30 s of EDOT dose time, 60 s of inert carrier gas purge, 30 s of MoCl₅ dose, and 60 s of inert carrier gas purge. This A/B dosing cycle is expected to result in ˜1 nm or less of PEDOT thickness deposited on the polymer sponge, and can be repeated to produce PEDOT coatings of desired thickness within the polyurethane sponge. PEDOT films are both conductive and redox-active, and alter the polyurethane to form a compressible, ion-binding and electrically-chargeable sponge electrode.

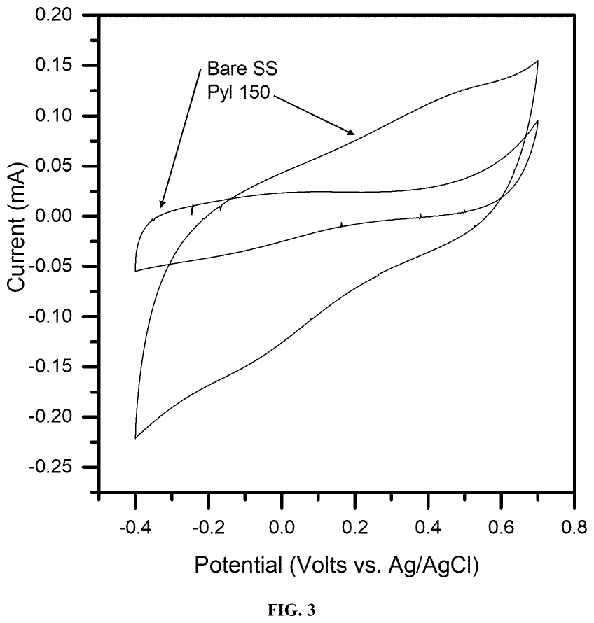

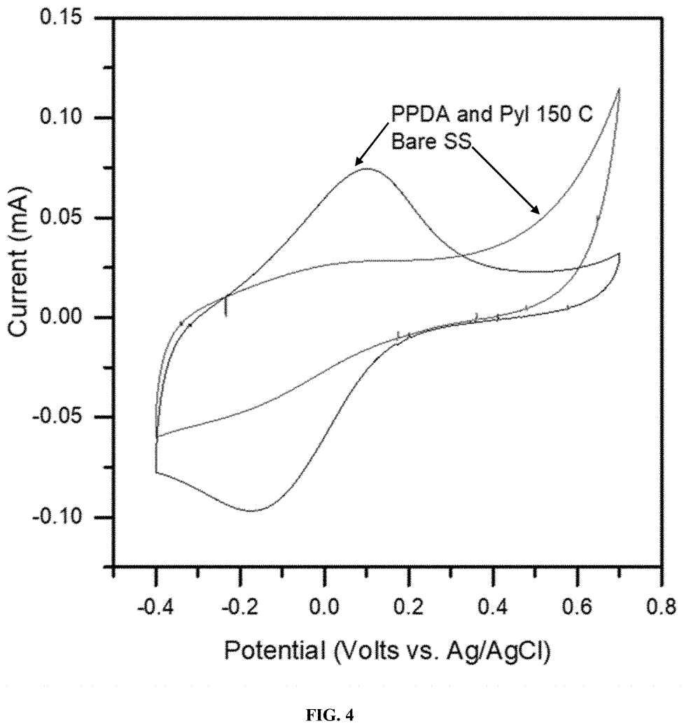

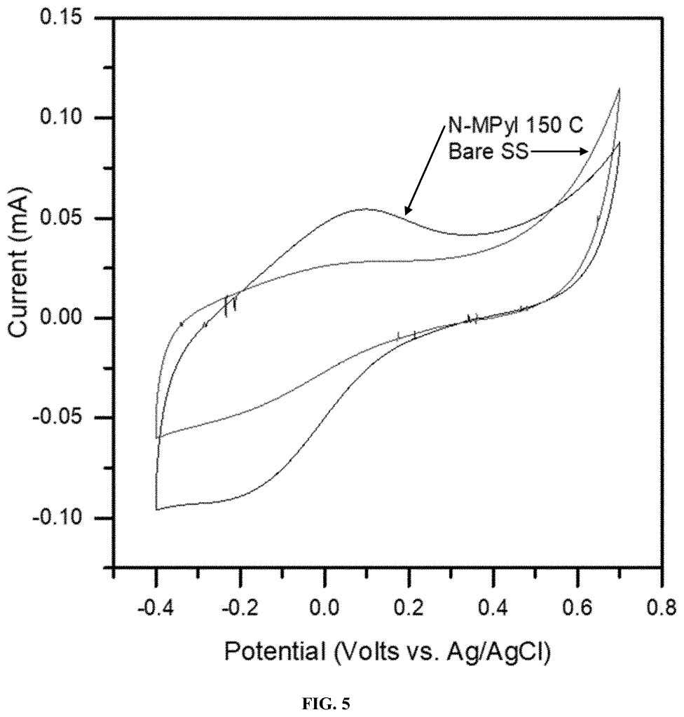

The electrochemical properties of exemplary electrochemical ion binding coatings of the invention were measured, and the results of those measurements are shown in FIGS. 3 (polypyrrole), 4 (polyPPDA/pyrrole), and 5 (poly-n-methyl-pyrrole). A description of the formation of these coatings on stainless steel discs and the measurement of their electrochemical properties is set forth below in Example 2.

### Example 2

ALD was performed in a hot-walled viscous flow reactor at 150 degrees Celsius under a continuous argon purge of 200 sccm (0.8 Torr). For each growth condition, 20 oMLD cycles were performed using sequential exposure of a monomer and an MoCl₅ oxidant. The MoCl₅ oxidant was held at 65 degrees Celsius and each monomer was held at room temperature. The dosing scheme for one oMLD cycle consisted of: 55 second MoCl₅ dose, 200 second Ar purge, 6 second monomer dose, 200 second Ar purge. For the reported electrochemical characterization, clean as-received ⅝″ diameter 316L stainless steel discs were placed on the sample tray in the oMLD reactor and allowed to reach 150 C under continuous argon purge before starting the deposition. Twenty cycles of oMLD were then performed using the dosing scheme outlined above. Following deposition, the stainless steel samples were removed from the reactor chamber, allowed to cool, and then placed in a custom glass 3-electrode electrochemical cell for flats evaluation. The glass cell was filled with ˜8 mL of an aqueous sulfuric acid solution (pH 2), purged using argon gas, and then cyclic voltammetry was performed under an argon blanket purge using a graphite rod counter electrode and a silver silver/chloride reference electrode. The oMLD process using (a) pyrrole only, (b) a 1:1 alloy of para-phenylenediamine (PPDA) and pyrrole and (c) n-methyl pyrrole only resulted in increased electrochemical capacity above the control from these electrochemical measurements, indicating that these oMLD processes successfully resulted in coatings of (a) polypyrrole, (b) poly-n-methyl-pyrrole, and (c) polyPPDA/pyrrole. The polyPPDA/pyrrole growth was performed in a fashion where the monomer dose alternated between PPDA and pyrrole every cycle for a total of 20 cycles.

From the foregoing it will be seen that this invention is one well adapted to attain all ends and objectives herein-above set forth, together with the other advantages which are obvious and which are inherent to the invention.

Since many possible embodiments may be made of the invention without departing from the scope thereof, it is to be understood that all matters herein set forth or shown in the accompanying drawings are to be interpreted as illustrative, and not in a limiting sense.

While specific embodiments have been shown and discussed, various modifications may of course be made, and the invention is not limited to the specific forms or arrangement of parts and steps described herein, except insofar as such limitations are included in the following claims. Further, it will be understood that certain features and subcombinations are of utility and may be employed without reference to other features and subcombinations. This is contemplated by and is within the scope of the claims.

What is claimed and desired to be secured by Letters Patent is as follows:

1. A porous electrode, comprising:
a porous substrate comprising internal pores having internal pore surfaces; and
a coating;
wherein the coating covers at least a portion of the interior pore surfaces; and
wherein the coating is electrically conductive and ion-binding.

2. The porous electrode of claim 1, wherein the porous substrate is compressible.

3. The porous electrode of claim 2, wherein the porous substrate is a compressible foam, and wherein the porous electrode is a compressible foam electrode.

4. The porous electrode of claim 1, wherein the coating comprises a polymer.

5. The porous electrode of claim 1, wherein the coating is formed by sequential infiltration synthesis.

6. The porous electrode of claim 4, wherein the polymer is formed by reacting a monomer and an oxidant.

7. The porous electrode of claim 6, wherein the monomer is selected from the group consisting of substituted or unsubstituted pyrrole, aniline, para-phenylenediamene, thiopene, cyclic or acyclic conjugated monomers containing N, and/or S heteroatoms, and combinations thereof.

8. The porous electrode of claim 7, wherein the monomer is selected from the group consisting of 3,4-ethylenedioxythiophene, n-methyl aniline, n-methyl pyrrole, and combinations thereof.

9. The porous electrode of claim 4, wherein the polymer is poly(3,4-ethylenedioxythiophene).

10. The porous electrode of claim 6, wherein the oxidant is selected from the group consisting of halides, metal halide oxidants, and combinations thereof.

11. The porous electrode of claim 10, wherein the metal halide oxidant is selected from the group consisting of molybdenum pentachloride (MoCl₅), iron chloride (FeCl3), tin chloride (SnCl4), arsenic chloride (AsCl5), rhenium chloride (ReCl5), copper chloride (CuCl2), palladium chloride (PdCl2), antimony chloride (SbCl5), and combinations thereof.

12. The porous electrode of claim 1, wherein a thickness of the coating ranges from 1 to 1000 nm.

13. The porous electrode of claim 1, wherein the thickness of the coating is approximately 1/100^{th} the diameter of the pores of the porous substrate.

14. The porous electrode of claim 1, wherein a porosity of the porous substrate ranges from 0.05% to 99%.

15. The porous electrode of claim 1, wherein a surface area of the porous substrate ranges from 0.1 to 100 m²/g.

16. The porous electrode of claim 1, wherein an electrical conductivity of the coating ranges from 1 to 5,000 S/cm.

17. The porous electrode of claim 16, wherein the electrical conductivity is greater than 5,000 S/cm.

18. The porous electrode of claim 1, wherein a sorption capacity of the coating ranges from 10 to 2000 F/g.

19. The porous electrode of claim 18, wherein the sorption capacity is greater than 500 F/g.

20. The porous electrode of claim 1, wherein a resistance of the coating ranges from 1 to 10,000 Ohms.

21. The porous electrode of claim 20, wherein the resistance is about 10 Ohms.

22. A method of deionizing water, comprising:
applying a charge to the porous electrode of claim 1; and
contacting the water with the porous electrode.

23. The method of claim 22, wherein the applying step comprises applying a potential difference over two porous electrodes of claim 1; and
the contacting step comprises contacting the water with each of the porous electrodes.

24. A capacitive deionization system for deionizing water, comprising:
the compressible porous electrode of claim 2; and
a device configured to mechanically compress the porous compressible electrode.
